(19) United States
(12) Patent Application Publication
(10) Pub. No.: US 2025/0190802 A1
(43) Pub. Date: Jun. 12, 2025

(54) METHOD AND SYSTEM FOR CONTRASTIVE LEARNING OF CONTEXTUAL RETRIEVAL AUGMENTED GENERATION

(71) Applicant: Zensar Technologies Limited, Pune (IN)

(72) Inventor: Indrajit Kar, Pune (IN)

(21) Appl. No.: 18/532,870

(22) Filed: Dec. 7, 2023

(51) Int. Cl. G06N 3/0895; G06N 3/0455

(52) U.S. Cl. CPC G06N 3/0895; G06N 3/0455

(57) ABSTRACT

The present disclosure leverages self-supervised learning to generate positive and negative question-context pairs, enabling the model to learn robust representations. This process involves data augmentation techniques to create variations of the original questions and contexts while preserving semantic relevance. A large corpus of unlabelled text data containing questions and their corresponding contexts, ensuring diversity and representativeness across various topics are used to train a self-supervised Large Language retrieval model.

### TECHNICAL FIELD

The present disclosure relates to self-supervised learning framework. The present disclosure further relates to contrastive learning of contextual retrieval augmented generation using semi-supervised retriever.

### BACKGROUND

Generative Artificial Intelligence (AI) has become ubiquitous owing to its capability to answer diverse questions related to different fields and its knowledge base. Recent generative AIs use Retrieval Augmented Generation (RAG) mechanisms to retrieve content based on a user query. A typical setup of DPR uses aa Retriever model which is trained on a dataset of question-context pairs, and it learns to represent questions and contexts in a way that is similar to how humans do. The DPR is a specialized retrieval model designed for efficient and accurate information retrieval.

The DPR model has few technical problems in implementing. The DPR model requires a large dataset of question-context pairs. This dataset can be difficult and time-consuming to annotate. Incorrect context retrieval in a Retrieval-Augmented Generation (RAG) and deep passage retrieval (DPR) models can lead to inaccuracies or irrelevant information in the generated content. RAG models, which combine retrieval-based and generative approaches, rely on retrieving relevant documents or data as a context for generating responses. If the retrieval component fetches incorrect or unrelated context, the model's response may be off-topic, factually incorrect, or nonsensical.

Dense Passage Retrieval (DPR) models can also face similar problems with incorrect context retrieval. DPR models are designed to retrieve relevant documents or passages from a large corpus to answer a query. If the retrieval process fetches incorrect, irrelevant, or incomplete information, the quality of the output can be adversely affected.

DPR models work by encoding both the query and the documents into vector representations and then finding the documents whose vectors are closest to the query vector. However, if the encoding process doesn't capture the nuances of the query or if the corpus lacks comprehensive coverage, the retrieved documents might not be the best match. This can lead to answers that are off-topic, incomplete, or factually incorrect.

Just like in RAG models, the accuracy of retrieval is crucial in DPR models. The effectiveness of these models heavily depends on both the quality of the underlying data and the sophistication of the encoding mechanisms used for queries and documents.

The RAG model can sometimes hallucinate answers that are not supported by the context. This can happen when the model is not able to find a passage that is a perfect match for the question;

Handling longer contexts is a challenge in Dense Passage Retrieval (DPR) models. DPR is optimized for retrieving relevant information from shorter passages or documents. When dealing with longer contexts, several issues arise. First, the effectiveness of encoding diminishes as the length of the text increases, potentially leading to less accurate representations of the document's content. Second, longer documents might contain a mix of relevant and irrelevant information, making it harder for the model to identify the most pertinent parts in response to a query. Consequently, DPR models may struggle with precision and relevance when processing and retrieving information from longer documents.

In Retrieval-Augmented Generation (RAG) models, handling long contexts also poses significant challenges. RAG combines retrieval with generative modeling, fetching relevant documents to inform the generation process. However, when the context is lengthy, the model might struggle to effectively integrate and synthesize all the relevant information. This can result in overlooking key details or failing to maintain coherence over extended narratives. Furthermore, the generative component may not be able to effectively utilize all parts of a long context, leading to responses that are less accurate or only partially address the full scope of the input. Thus, maintaining accuracy and relevance in long-context scenarios remains a challenge for RAG models.

Handling ambiguous contexts in both Retrieval-Augmented Generation (RAG) and Dense Passage Retrieval (DPR) models is challenging. For RAG, ambiguity in the input can lead to the retrieval of less relevant documents, which in turn can result in the generation of responses that are off-topic or confusing. The generative component of RAG might struggle to resolve ambiguity without clear guidance from the retrieved context. Similarly, in DPR, ambiguous queries can cause the retrieval of a wide range of documents, many of which might be irrelevant. This impedes the model's ability to pinpoint the most pertinent information, affecting the overall accuracy and relevance of the output.

Achieving faster context retrieval in Dense Passage Retrieval (DPR) and Retrieval-Augmented Generation (RAG) models is also challenging. Both models require efficient retrieval of relevant information from large datasets, which can be time-consuming. For DPR, quickly scanning and ranking vast numbers of documents to find the most relevant ones demands optimized algorithms and powerful computational resources. Similarly, RAG not only needs to retrieve documents rapidly but also to seamlessly integrate this information into the generative process, balancing speed with accuracy and relevance. Improving retrieval speed without sacrificing the quality of results is a key challenge in enhancing the performance of these models.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure discloses a method for retrieving response using contrastive learning of contextual retrieval augmented generation. The method comprises receiving an input text indicating a query made by a user; and retrieving a response from one or more data sources based on the input text using a self-supervised retrieval model. The self-supervised retrieval model is pre-trained by: providing a plurality of unlabelled texts as training input data to the self-supervised retrieval model; determining a context of each unlabelled text in the plurality of unlabelled texts using one or more Artificial Intelligence (AI) techniques; performing an augmentation operation on each unlabelled text and the context corresponding to each unlabelled text; generating a plurality of positive and negative query-context pairs for the unlabelled text and the corresponding context based on the augmentation operation using the self-supervised retrieval model; and configuring the self-supervised retrieval model to retrieve the response from the one or more data sources in response to each unlabelled text.

In an embodiment, the present disclosure discloses a computer system, comprising: a memory; and one or more processors. The one or more processors are configured to: receive an input text indicating a query made by a user; and retrieve a response from one or more data sources based on the input text using a self-supervised retrieval model. The self-supervised retrieval model is pre-trained by the processor, where the processor is configured to: provide a plurality of unlabelled texts as training input data to the self-supervised retrieval model; determine a context of each unlabelled text in the plurality of unlabelled texts using one or more Artificial Intelligence (AI) techniques; perform an augmentation operation on each unlabelled text and the context corresponding to each unlabelled text; generate a plurality of positive and negative query-context pairs for the unlabelled text and the corresponding context based on the augmentation operation using the self-supervised retrieval model; and configure the self-supervised retrieval model to retrieve the response from the one or more data sources in response to each unlabelled text.

In an embodiment, the present disclosure discloses a non-transitory computer readable storage media. The storage media comprises instructions that when executed causes a processor to receive an input text indicating a query made by a user; and retrieve a response from one or more data sources based on the input text using a self-supervised retrieval model. The self-supervised retrieval model is pre-trained by: providing a plurality of unlabelled texts as training input data to the self-supervised retrieval model; determining a context of each unlabelled text in the plurality of unlabelled texts using one or more Artificial Intelligence (AI) techniques; performing an augmentation operation on each unlabelled text and the context corresponding to each unlabelled text; generating a plurality of positive and negative query-context pairs for the unlabelled text and the corresponding context based on the augmentation operation using the self-supervised retrieval model; and configure the self-supervised retrieval model to retrieve the response from the one or more data sources in response to each unlabelled text.

The foregoing summary is illustrative only and is not intended to be in any way limiting. In addition to the illustrative aspects, embodiments, and features described above, further aspects, embodiments, and features will become apparent by reference to the drawings and the following detailed description

### BRIEF DESCRIPTION OF DRAWINGS

The accompanying drawings, which are incorporated in and constitute a part of this disclosure, illustrate exemplary embodiments and, together with the description, serve to explain the disclosed principles. The same numbers are used throughout the figures to reference like features and components. Some embodiments of device and/or methods in accordance with embodiments of the present subject matter are now described, by way of example only, and with reference to the accompanying figures, in which:

FIG. 1 illustrates a simplified block diagram of a an environment of contrastive learning of contextual retrieval augmented generation using self-supervised retriever, in accordance with some embodiments of the present disclosure;

FIG. 2 discloses an exemplary illustration of a computer system for implementing a self-supervised retriever, in accordance with some embodiments of the present disclosure;

FIG. 3 discloses an exemplary flowchart illustrating method steps for pre-training a self-supervised retriever, for contrastive learning of contextual retrieval augmented generation, in accordance with some embodiments of the present disclosure;

FIG. 4 discloses an exemplary flowchart illustrating method steps for inference of a self-supervised retriever, for contrastive learning of contextual retrieval augmented generation, in accordance with some embodiments of the present disclosure;

FIG. 5A illustrates an exemplified hybrid diagram showing the steps and blocks involved in implementing a self-supervised retriever; in accordance with some embodiments of the present disclosure;

FIG. 5B illustrates an exemplified detailed diagram for implementation of self-supervised retriever, in accordance with some embodiments of the present disclosure; and

FIG. 6 discloses an exemplified general purpose computer for implementing a self-supervised retriever; in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and may be executed by an apparatus, an example of such apparatus may be a computer or processor.

### DETAILED DESCRIPTION

In the present document, the word “exemplary” is used herein to mean “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

It shall be noted that, for convenience of explanation, the disclosure uses terms and names that are known in the field of Artificial Intelligence (AI), Machine Learning (ML), Deep Learning (DL), Retrieval Augmented Generation (RAG), Large Language Models (LLM), and supervised learning.

The present disclosure leverages self-supervised learning to generate positive and negative question-context pairs, enabling the model to learn robust representations. This process involves data augmentation techniques to create variations of the original questions and contexts while preserving semantic relevance. A large corpus of unlabelled text data containing questions and their corresponding contexts, ensuring diversity and representativeness across various topics are used to train a self-supervised model.

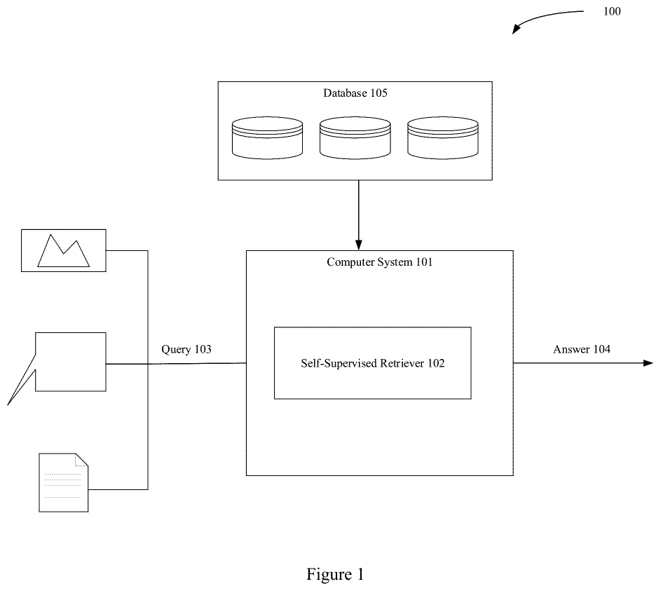

FIG. 1 illustrates a simplified block diagram of a an environment 100 of contrastive learning of contextual retrieval augmented generation using self-supervised retriever, in accordance with some embodiments of the present disclosure. The environment 100 comprises a computer system 101 and one or more databases 105. The environment 100 may additionally include one or more devices (not shown) making a query 103. The one or more devices may be associated with a user or another system associated with the computer system 101. The one or more devices may include a mobile phone, a laptop, a computer, a tablet, a Personal Device Assistant (PDA), a server, a digital assistant and the like. The one or more devices may generate a query 103 which is input to the computer system 101. The query 103 may be prompted by the user or the other system. For example, a user may ask a query about schools near Seattle. In another example a medical server associated with the computer system 101 may upload a medical document which needs to be analysed. In this example, the document having text can be the query 103. In another example, the query 103 can be an image file. The image file may include text or objects that may indicate the query 103.

The one or more databases 105 may be knowledge databases. In an embodiment, the one or more databases 105 may be vector databases. The vector databases may be designed to store, manage and index large quantities of high-dimensional vector data. In the vector databases, datapoints are represented as vectors with a fixed number of dimensions. Image data, text data, speech data can be represented as vectors and are stored in the vector databases.

The computer system 101 comprises a self-supervised retriever 102. The self-supervised retriever 102 is used to retrieve information from the one or more databases 105 relevant to the query 103. In an embodiment, the self-supervised retriever 102 may be a Large Language Model (LLM) configured to recognize, translate, predict and generate text and other content based on the query 103. The self-supervised retriever 102 may also be referred as self-supervised large language retrieval model. The self-supervised retriever 102 may be used in different use cases including but not limited to, information retrieval, sentiment analysis, text generation, code generation, and conversational systems such as chatbots and digital assistants. Unlike existing retriever such as the Dense Passage Retriever (DPR) which relies on annotated training dataset, the self-supervised retriever 102 makes use of unlabelled training data, which reduces human annotation making the proposed system and method efficient and cost-effective.

Further, the self-supervised retriever 102 implements contrastive learning which leverages the context aware learning for the input query 103, and the generated answer 104 is relevant to the context of the query 103, unlike the DPR where the answer are not always generated relevant to the context of all queries.

Details regarding the implementation of the computer system 101 are described further in the present disclosure.

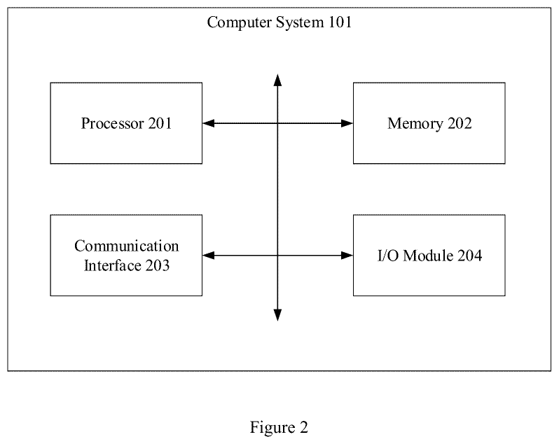

FIG. 2 discloses an exemplary illustration of a computer system 101 for implementing a self-supervised retriever 102, in accordance with some embodiments of the present disclosure.

FIG. 2 illustrates a simplified representation of internal architecture of the computer system 101. In some embodiments, the illustration of FIG. 2 shows elements that are required to implement the proposed solution. However, a person skilled in the art will appreciate that the computer system 101 may include more or less elements and the scope of computer system 101 may not be limited to the illustration made in FIG. 2. In an embodiment, the.computer system 101 uses the self-supervised retriever 102 for generating an answer 104 in response to the query 103.

The computer system 101 comprises one or more processors collectively referred as processor 201 in FIG. 2, a memory 202, a communication interface 203, and an Input/Output (I/O) module 204.

In an embodiment, the processor 201 may be part of a server/servers and host a database. Some examples of the database include, but not limited to, a registry, a relational database, a NoSQL database, Graph database, time-series based database, minio, chartmuseum, Persistent Volume (PV), application database, and the like. Registry is configured to store a plurality of docker images in layered fashion. The NoSQL data, graph data, time-series based data, LCM data, and monitoring data of CNFs/VNFs may be stored in relational and time-series based stores. Minio is an object storage to store very large files like CNF package, VNF package, etc. The CNFs/VNFs package usually contain helm packages, docker images and metadata. During CNF package on boarding, helm charts are stored in chartmuseum.

In one embodiment, the processor 201 may be embodied as a multi-core processor, a single core processor, or a combination of one or more multi-core processors and one or more single core processors. For example, the processor 201 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like.

In one embodiment, the memory 202 is capable of storing machine executable instructions, referred to herein as instructions. In an embodiment, the processor 201 is embodied as an executor of software instructions. As such, the processor 201 is capable of executing the instructions stored in the memory 202 to perform one or more operations described herein.

The memory 202 can be any type of storage accessible to the processor 201 to perform respective functionalities, as will be explained in detail with reference to FIGS. 2 to 5. For example, the memory 202 may include one or more volatile or non-volatile memories, or a combination thereof. For example, the memory 202 may be embodied as semiconductor memories, such as flash memory, mask ROM, PROM (programmable ROM), EPROM (erasable PROM), RAM (random access memory), etc. and the like.

In an embodiment, the I/O module 204 may include mechanisms configured to receive inputs from and provide outputs. In an embodiment, the I/O module 204 may be used to integrate the computer system 101 with the one or more devices, the one or more databases 105.

To enable reception of inputs and provide outputs to computer system 101, the I/O module 204 may include at least one input interface and/or at least one output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, and the like. It shall be noted that some network nodes in a wireless communication system may not include all the components listed above in the input interface/output interface and hence it should be apparent to a person skilled in the art that embodiments of the present disclosure may be practiced without the input interface/output interface.

The communication interface 203 may be configured to receive the query 103 from the one or more devices. As described earlier, the query 103 may be a text, an image or a document having preferably text data. The communication interface 203 may be further configured to provide the answer 104 to the query 103 generated by the computer system 101 to the one or more devices or any other connected devices. In some embodiments, the communication interface 203 may be configured to retrieve data from the one or more databases 105 relevant to the query 103. In some embodiments, the communication interface 203 may be configured to receive a plurality of unlabelled texts as inputs for training the self-supervised retriever 102.

In some embodiments the processor 201 is configured to receive an input text indicating the query 103 made by a user and retrieve the answer 104 (also referred as response) from the one or more one or more databases 105 (also referred as data sources) in response to the query 103 using the self-supervised retriever 102. In contrast to the existing systems, the self-supervised retriever 102 is trained using unlabelled dataset. The processor 201 provides the plurality of unlabelled text as input to the self-supervised retriever 102 during a training stage. Further, the processor determines a context of each unlabelled text using one or more AI techniques. Thereafter, the processor 201 is configured to augment the unlabelled text and the context to generate positive and negative query-context pairs. Further, the processor 201 configures the self-supervised retriever 102 to retrieve the answer 104 to the input unlabelled text. Thus the self-supervised retriever 102 is trained to retrieve the answer 104 considering the context associated with the query 103.

In an embodiment, the processor 201 is configured to further train the self-supervised retriever 102. The processor 201 receives a plurality of test query-context representations such that each test query-context representation indicates a test query and a corresponding context of the test query. Further, the processor 201 provides labelled query-context pairs to the self-supervised retriever 102 and optimizes the self-supervised retriever 102 to retrieve the response from the one or more databases 105 based on the labelled query-context pairs.

In an embodiment, the processor 201 is configured to evaluate a quadruplet loss function by evaluating a loss between the response 104 retrieved by the self-supervised retriever 102 and an expected response. The quadruplet loss function is based on the positive and negative query-context pairs for each of the unlabelled text and the corresponding context.

In an embodiment, the processor 201 is configured to store the plurality of positive and negative query-context pairs for the unlabelled text and the corresponding context as a plurality of vector embeddings that includes multimodal Vector and index the plurality of vector embeddings corresponding to the plurality of unlabelled texts.

In an embodiment, for generating the plurality of positive and negative query-context pairs for the unlabelled text and the corresponding context, the processor is further configured to identifying a positive sample from the positive and negative query-context pair when a semantic meaning associated with an augmented unlabelled text and the corresponding context is similar to the unlabelled text and the corresponding context. Further, the processor 201 is configured to identify a negative sample from the positive and negative query-context pair when a semantic meaning associated with an augmented unlabelled text and the corresponding context is different from the unlabelled text and the corresponding context.

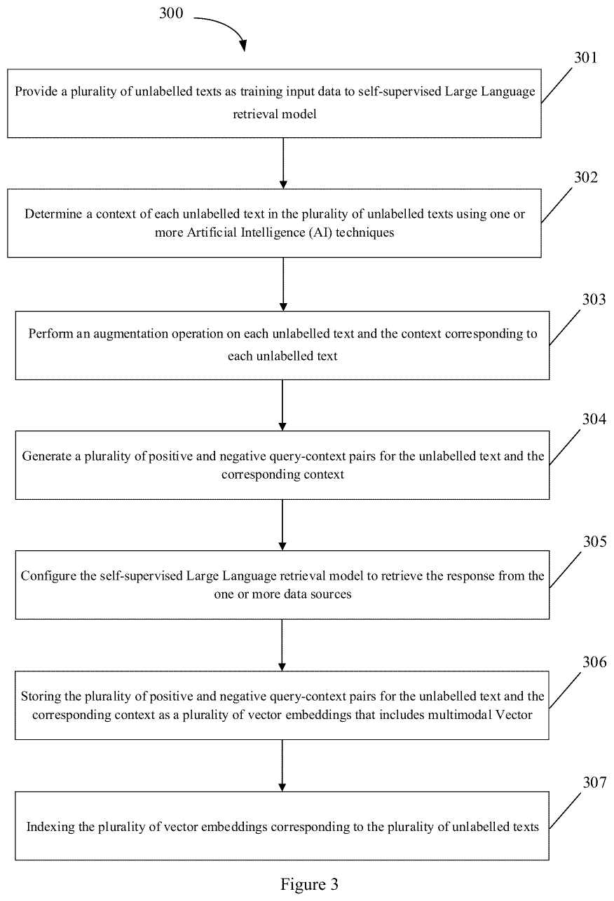

FIG. 3 is a flowchart illustrating a method 300 for contrastive learning of contextual retrieval augmented generation for large language model during the training stage. The method 300 depicted in the flow diagram may be executed by the processor 201. Operations of the flow diagram, and combinations of operation in the flow diagram, may be implemented by, for example, hardware, firmware, a processor, circuitry and/or a different device associated with the execution of software that includes one or more computer program instructions. The operations of the method 300 are described herein with help of the processor 202 embodied within the computer system 101. It is noted that the operations of the method 300 can be described and/or practiced by using one or more processors 101. The method 300 begins with pre-training. Pre-training includes creation of positive and negative query-context pairs, where data augmentation is applied separately to query and contexts. In an embodiment, a suitable model like BERT or other transformer-based models may be used for pre-training. During pre-training, the model learns to create meaningful representations for both positive and negative query-context pairs. The pre-training comprises the following steps.

At step 301, providing the plurality of unlabelled texts as training input data to the self-supervised retriever 102. Self-supervised learning uses the data to provide the supervisory signals for representation learning without any other annotating processes. In an embodiment, pseudo labels can be provided to the training input data. The pseudo labels reduces the time and effort required especially when large datasets are considered. Examples of input unlabelled text may include, “Where is my order” or “how is the weather today” or “which is the best car insurance”. In an embodiment, the training input data may originate from various sources, including document repositories, databases, or Application Program Interfaces (APIs). In a first step the documents and the query 103 are converted into a format that enables comparison and relevant search. This involves transforming the document collection (knowledge library) and the query 103 into numerical representations using embeddings from language models. These embeddings serve as numerical representations of concepts within the text. Further, using the embedding of the query 103, the relevant text is identified in the document collection through a similarity search conducted in the embedding space. The prompt provided by the user is then augmented with the searched relevant text and added to the context. Subsequently, the augmented prompt is passed to the large language model, and since the context now includes external data alongside the original prompt, the generated model output becomes more relevant and accurate.

At step 302, determining a context of each unlabelled text in the plurality of unlabelled texts using one or more AI techniques. Recurrent Neural Networks (RNN) or Long Short-Term Memory (LSTM) networks may be employed to determine the context of the unlabelled text. Examples of the context may include, “order details” or “weather information” or “list of car insurance policies”.

At step 303, performing an augmentation operation on each unlabelled text and the context corresponding to each unlabelled text. In an embodiment, the augmentation allows the semi-supervised retriever 102 to learn different variations of the input query 103. The augmentation is performed such that the semantic meaning of the input query 103 is the similar. Techniques such as random insertions, random swap, random deletion, synonym replacement can be used to generate augmented sentences. Other techniques that may be used are back translation, cut-off and drop-out techniques. The back translation technique may be used to preserve the semantic meaning of the original query 103. In some embodiment, the input query 103 can be considered as an anchor and a positive sample may be generated by augmenting the query 103 and other samples in the training data can be considered as negative samples. In some embodiments, the input query 103 may be augmented to generate the positive samples and the negative samples. In an embodiment, the input query 103 and the context determined for the input query 103 are augmented to generate the query-context pair. For example, for the input text, “how is the weather today”, a positive sample may be “what is the weather like today” or “today's weather”. A negative sample may be “how is the weather tomorrow” or “how was the weather yesterday”. A context associated with the input query 103 may be “information regarding today's weather”. A positive context may be “weather report for today”, and a negative context may be “weather report for tomorrow”. In some embodiments, the step of augmentation may be a pre-training step. In some embodiments, BERT or encoder models or any suitable transformer models can be used for pre-training.

At step 304, generating a plurality of positive and negative query-context pairs for the unlabelled text and the corresponding context based on the augmentation operation using the self-supervised Large Language retrieval model. Using the augmented results, the positive and negative query-context pair is generated such that a positive sample of the query 103 and the positive sample of the context derived for the query 103 are paired as positive query-context pair and a negative sample of the query 103 and the negative sample of the context derived for the query 103 are paired as negative query-context pair. In some embodiments, the positive sample of the query 103 and the positive sample of context are identified based on the semantic meaning associated with the samples and the input query 103. Likewise, the negative sample of the query 103 and the negative sample of context are identified based on the semantic meaning associated with the samples and the input query 103. For example, when the semantic meaning of a sample of the text query 103 and the context matches the semantic meaning of the input text query 103, then such samples is considered as positive query-context pair. Similarly, when the semantic meaning of a sample of the text query 103 and the context do not match the semantic meaning of the input text query 103, then such samples is considered as positive query-context pair.

At step 305, configuring the self-supervised LLM to retrieve the response from the one or more data sources 105.

In some embodiments, a loss function is evaluated. The loss function may be a quadruplet loss function. Equation 1 below discloses the loss function.

$$LCQC ( q , c ) = Σ i = 1 N max ( 0 , sim ( f ( qi ) , f ( ci ) ) - sim ( f ( qi ) , f ( cj ) ) + α ) + max ( 0 , sim ( f ( qi ) , f ( ci ) ) - sim ( f ( cpositive ) , f ( cnegative ) ) + α ) \qquad ( 1 )$$

where:
f(·) is the representation function that maps the input question or context to its embedding.
sim(f(qi),f(ci)) is the similarity score between the question and context representations.
sim(f(qi),f(cj)) is the similarity score between the question and a different context (negative) representation.
sim(f(cpositive),f(cnegative)) is the similarity score between the similar context (context_positive) and the dissimilar context (context_negative).
N is the number of training instances.
α is the margin, which ensures a gap between the positive and negative similarity scores.

In some embodiments, the quadruplet loss tries to minimize the distance between the anchor and the positive samples and increase the distance between the anchor and the negative samples.

In some embodiments, once the pre-training is complete, the self-supervised retriever 102 is trained with test queries. The process includes receiving a plurality of test query-context representations such that each test query-context representation indicates a test query and a corresponding context of the test query. Further process includes providing labelled query-context pairs to the self-supervised retriever 102 and optimizing the self-supervised Large retriever 102 to retrieve the response from the one or more data sources based on the labelled query-context pairs. This ensures the self-supervised retriever 102 is fine-tuned and the retrieval action is effective resulting in relevant answers 104.

At step 306, the method comprises storing the plurality of positive and negative query-context pairs for the unlabelled text and the corresponding context as a plurality of vector embeddings that includes multimodal Vector and indexing the plurality of vector embeddings corresponding to the plurality of unlabelled texts. In an embodiment, the vector embedding is also referred as context embedding in the present disclosure.

At step 307, indexing the plurality of vector embeddings corresponding to the plurality of unlabelled texts. In an embodiment, the indexing is performed using dictionaries. Positive and negative query and context embeddings are stored as a dictionary and the dictionary acts as the index for the embeddings. Keys such as query IDs and context IDs are used as unique identifiers.

In a first instance, positive samples of the query 103 are stored as positive query embedding in the dictionary. A unique positive query ID is associated while adding the positive query embedding to the dictionary. The vector embedding is associated with the unique positive query ID. To retrieve a specific positive query embedding, a retrieve function is used with the unique ID and by specifying that the required embedding is a positive query embedding. A remove function enables to remove the positive query embedding from the dictionary. The unique ID and the vector embedding are removed.

In a second instance, negative samples of the query 103 are stored as negative query embedding in the dictionary. A unique negative query ID is associated while adding the negative query embedding to the dictionary. The vector embedding is associated with the unique negative query ID. To retrieve a specific negative query embedding, a retrieve function is used with the unique ID and by specifying that the required embedding is a negative query embedding. A remove function enables to remove the negative query embedding from the dictionary. The unique ID and the vector embedding are removed.

In a third instance, negative samples of the context are stored as negative context embedding in the dictionary. A unique negative context ID is associated while adding the negative context embedding to the dictionary. The vector embedding is associated with the unique negative context ID. To retrieve a specific negative context embedding, a retrieve function is used with the unique ID and by specifying that the required embedding is a negative context embedding. A remove function enables to remove the negative context embedding from the dictionary. The unique ID and the vector embedding are removed.

In a fourth instance, positive samples of the context are stored as positive context embedding in the dictionary. A unique positive context ID is associated while adding the positive context embedding to the dictionary. The vector embedding is associated with the unique positive context ID. To retrieve a specific positive context embedding, a retrieve function is used with the unique ID and by specifying that the required embedding is a positive context embedding. A remove function enables to remove the positive context embedding from the dictionary. The unique ID and the vector embedding are removed.

In this way, dictionaries are used to index and manage embeddings based on their type (positive or negative) and their associated IDs (question IDs or context IDs). Thus indexing allows for efficient storage, retrieval, and removal of embeddings when needed.

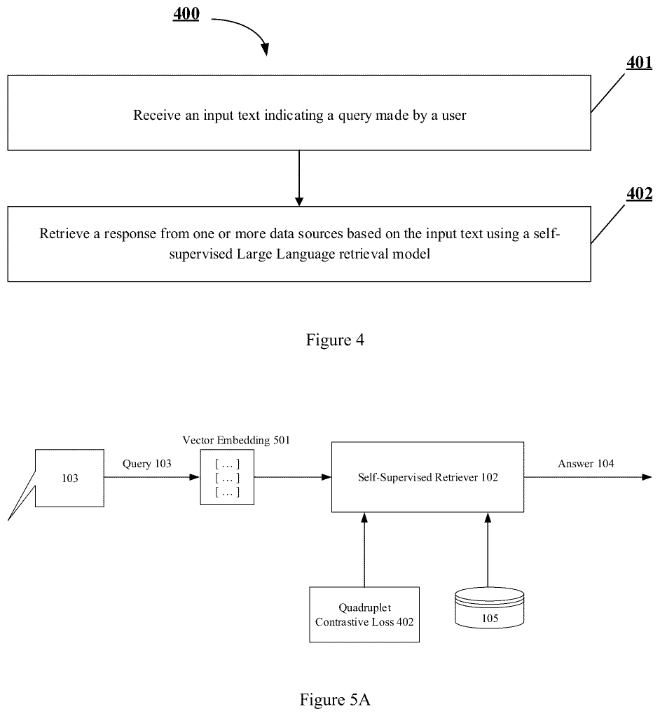

Reference is now made to FIG. 4 which illustrates the inference stage of the self-supervised retriever 102.

At step 401, receiving input text indicating the query 103 made by the user.

At step 402, retrieving a response (answer) 104 from the one or more databases 105 based on the input text using the self-supervised retriever 102.

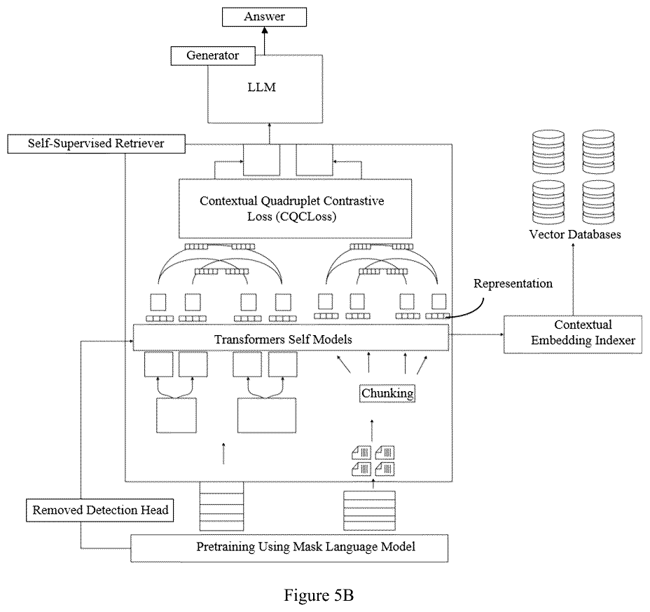

The above steps are described by making reference to FIG. 5A. As shown in FIG. 5A, the self-supervised retriever 102 receives the user query 103 as an input. The query 103 is converted to vector embeddings 501. Vector embeddings 501 are vectors represented in a continuous, multi-dimensional space known as an embedding, which are generated by embedding models. Vector embeddings are a numerical representation of data, grouping sets of data based on semantic meaning or similar features. Further, the vector embedding is given as input to the self-supervised retriever 102. The self-supervised retriever 102 which is pre-trained and fine-tuned, is configured to retrieve an answer 104 in response to the input query 103. The response retrieval is performed by retrieving relevant passages from the one or more databases 105. The process involves determining a context of the input query 103 and a context associated with the input query 103. Further, the self-supervised retriever 102 retrieves relevant results from the one or more databases 105 using the vector embeddings associated with the query 103 and the context. More specifically indexing is helpful to search through the one or more databases 105 effectively. The relevant passage is retrieved from the one or more databases 105 and is provided as the answer 104. The quadruplet loss function helps to minimize the distance between the positive samples of query and context and the input query 103 and the context associated with it. Thus, the quadruplet loss function helps in identifying most relevant passages.

FIG. 5B illustrates the implementation of the self-supervised retriever 102 during pre-training and the inference stage. As shown in the FIG. 5B, the self-supervised retriever 102 is pre-trained with a plurality of unlabelled texts as training input data. In an embodiment, the training input data is subjected to chunking. Chunking is a process of breaking down large pieces of text into smaller segments. Chunking helps in embedding content with little noise while still preserving semantic meaning. The training input data is further processed to determine a context of each text. Further, augmentation is performed to create variations of the original query and the context while preserving the semantic meaning. Further, the self-supervised retriever 102 is configured to retrieve a response to the input query based on the training. In an embodiment, the self-supervised retriever 102 is associated with a contextual embedding indexer configured to index the vector embeddings or the context embeddings in the one or more vector databases. In some embodiments, the contextual embedding indexer is implemented as given below:

class ContextualEmbeddingIndexer:
def__init__(self, embedding_dim):
# Initialize an empty database for positive and negative embeddings
self.positive_question_embeddings = { }
self.negative_question_embeddings = { }
self.positive_context_embeddings = { }
self.negative_context_embeddings = { }
self.embedding_dim = embedding_dim
def add_positive_question_embedding(self, question_id, embedding):
# Add a positive question embedding to the database
if len(embedding) == self.embedding_dim:
self.positive_question_embeddings[question_id] = embedding
else:
raise ValueError(″Invalid embedding dimension.″)
def add_negative_question_embedding(self, question_id, embedding):
# Add a negative question embedding to the database
if len(embedding) == self.embedding_dim:
self.negative_question_embeddings[question_id] = embedding
else:
raise ValueError(″Invalid embedding dimension.″)
def add_positive_context_embedding(self, context_id, embedding):
# Add a positive context embedding to the database
if len(embedding) == self.embedding_dim:
self.positive_context_embeddings[context_id] = embedding
else:
raise ValueError(″Invalid embedding dimension.″)
def add_negative_context_embedding(self, context_id, embedding):
# Add a negative context embedding to the database
if len(embedding) == self.embedding_dim:
self.negative_context_embeddings[context_id] = embedding
else:
raise ValueError(″Invalid embedding dimension.″)
def search_similar_embeddings(self, query_embedding, threshold=0.5):
# Search for similar embeddings in the database based on a similarity
threshold similar_embeddings = [ ]
for question_id, embedding in self.positive_question_embeddings.items( ):
# Calculate similarity between query_embedding and stored embeddings
similarity = calculate_similarity(query_embedding, embedding)
if similarity >= threshold:
similar_embeddings.append((question_id, similarity))
return similar_embeddings
def calculate_similarity(self, embedding1, embedding2):
# Implement a similarity metric (e.g., cosine similarity) calculation
# Return a similarity score between the two embeddings
pass
def retrieve_embedding(self, question_id, is_positive=True):
# Retrieve a specific embedding from the database based on question ID
if is_positive:
if question_id in self.positive_question_embeddings:
return self.positive_question_embeddings[question_id]
else:
if question_id in self.negative_question_embeddings:
return self.negative_question_embeddings[question_id]
return None
def remove_embedding(self, question_id, is positive=True):
# Remove a specific embedding from the database based on question ID
if is_positive:
if question_id in self.positive_question_embeddings:
del self.positive_question_embeddings[question_id]
else:
if question_id in self.negative_question_embeddings:
del self.negative_question_embeddings[question_id]

FIG. 5B also discloses the contextual quadruplet contrastive loss. The quadruplet loss function is described in equation 1 above. In some embodiment, the contextual quadruplet contrastive loss function may be implemented as given below:

```
import torch
import torch.nn as nn
import torch.nn.functional as F
class CQCLoss(nn.Module):
def__init__(self, alpha=0.2):
      super(CQCLoss, self).__init__( )
      self.alpha = alpha
def forward(self, question_rep, context_rep, context_positive_rep, context_
negative_rep):
```

where question_rep (torch. Tensor) is the tensor representing the question embeddings. context_rep (torch. Tensor) is the tensor representing the original context embeddings. context_positive_rep (torch. Tensor) is the tensor representing the positive context embeddings. context_negative_rep (torch. Tensor) is the tensor representing the negative context embeddings.

The following describes the different use cases of the proposed solution.

### Use Case 1—Visual Image Search and Conversational Assistant:

A user uploads a picture of a pair of shoes in a shopping platform and queries to show similar results for shopping. The shopping platform implementing the proposed solution identifies a catalogue of similar shoes and creates a comparison table. The table is displayed to the user for selection. Details regarding the user selected shows is retrieved and displayed for purchasing. Further, offers and reviews are optionally displayed.

### Use Case 2—Insurance Buying Assistant:

A user opens an insurance provider app and a chatbot pops up. The chatbot asks for the user verification details to continue search. After successful verification, the chatbot asks for user query. Once the user keys in the query (or provides voice input), the chatbot provides the different options available and relevant to the user query. Further, the chatbot offers best policy recommendation to the user. Once the user selects a policy, the details regarding the policy is retrieved and is presented to the user.

### Use Case 3—Insurance Document Extraction and Assistance:

A user/system uploads a medial record of a patient on medical server platform and input query to retrieve medical history of the patient and similar records in the system. The platform extracts relevant text from the document and retrieves the medical history of the patient from the database. Further, the platform searches for similar patient history and retrieves the information regarding such patients and presents to the user/system.

### Use Case 4—Enhancing Talent Management in Digital Twin:

Human Resource (HR) manager is looking for managing demand-supply for associates. The HR manager maps available associates with the raised customer demand. Associates are of varied skills and available under various categories. The HR manager provides input to a chatbot and asks the chatbot to run simulation. Further, the HR manager asks the chatbot to summarize the results in data driven strategic planning. The HR manager asks the chatbot to run reverse simulation. Further, the HR manager requests to explain the changes needed in the current process to match the desired results.

The proposed solution is not limited to above use cases and can be implemented in several other use cases as known to a person skilled in the art.

Data Efficiency: The self-supervised learning approach reduces the reliance on annotated data for training. By leveraging unlabelled text data and data augmentation techniques, it requires minimal human annotation, making it more efficient and cost-effective.

Context Understanding: The self-supervised learning approach, combined with data augmentation, allows the model to capture and understand broader context. This helps in more accurate and comprehensive retrieval of relevant information.

Generalization: The approach facilitates better generalization to diverse contexts and domains. By training on a wide range of topics and contexts, the model becomes more robust and adaptable to different information retrieval tasks.

Reduced Bias: Traditional models may inherit biases from human-annotated data. In contrast, self-supervised learning, with its data-driven and diverse training approach, is less prone to bias amplification, leading to fairer and more impartial results.

Scalability: Leveraging the power of self-supervised learning, large-scale language models can be trained effectively. These models can handle vast amounts of data and can be fine-tuned for specific tasks, such as retrieval-based question answering, with high performance.

Interpretable Responses: By retrieving relevant evidence for each response, the approach provides more interpretable and justifiable answers. Users can understand the rationale behind the model's response, enhancing transparency and trust.

Efficient Retrieval: Self-supervised learning, when combined with retrieval-based architectures like Dense Passage Retriever, enables fast and efficient retrieval of relevant passages, improving system response times and user experience.

Less Hallucination: With the use of data augmentation techniques, the model is less likely to produce hallucinated information in its responses, leading to more accurate and reliable answers.

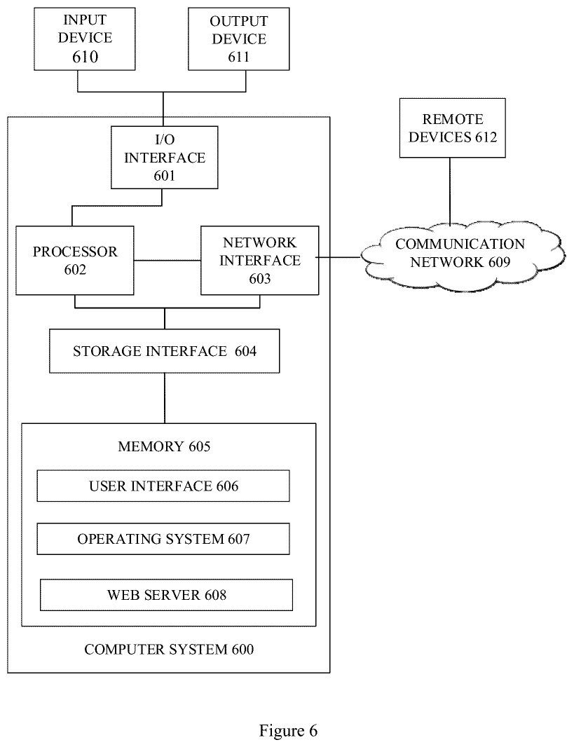

FIG. 6 shows a block diagram of a general-purpose computer contrastive learning of contextual retrieval augmented generation for large language model, in accordance with an embodiment of the present disclosure. The computer system 600 may comprise a central processing unit (“CPU” or “processor”) 602. The processor 602 may comprise at least one data processor. The processor 602 may include specialized processing units such as integrated system (bus) controllers, memory management control units, floating point units, graphics processing units, digital signal processing units, etc. The computer system 600 may be analogous to the geo-redundant operator 200 (shown in FIG. 2).

The processor 602 may be disposed in communication with one or more input/output (I/O) devices (not shown) via I/O interface 601. The I/O interface 601 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 601, the computer system 600 may communicate with one or more I/O devices. For example, the input device 610 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 611 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system 600 is connected to the remote devices 612 through a communication network 609. The processor 602 may be disposed in communication with the communication network 609 via a network interface 603. The network interface 603 may communicate with the communication network 609. The network interface 603 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 609 may include, without limitation, a direct interconnection, local area network (LAN), wide area network (WAN), wireless network (e.g., using Wireless Application Protocol), the Internet, etc. Using the network interface 603 and the communication network 609, the computer system 600 may communicate with the remote devices 612. The network interface 603 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 609 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, 3GPP and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 602 may be disposed in communication with a memory 605 (e.g., RAM, ROM, etc. not shown in FIG. 5) via a storage interface 604. The storage interface 604 may connect to memory 605 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, user interface 606, an operating system 607, web server 608, etc. In some embodiments, computer system 600 may store user/application data, such as, the data, variables, records, etc., as described in this disclosure. Such databases may be implemented as fault-tolerant, relational, scalable, secure databases such as Oracle® or Sybase®.

The operating system 607 may facilitate resource management and operation of the computer system 600. Examples of operating systems include, without limitation, APPLE MACINTOSH® OS X, UNIX®, UNIX-like system distributions (e.g., BERKELEY SOFTWARE DISTRIBUTION™ (BSD), FREEBSD™, NETBSD™, OPENBSD™, etc.), LINUX DISTRIBUTIONS™ (e.g., RED HAT™, UBUNTU™, KUBUNTU™, etc.), IBM™ OS/2, MICROSOFT™ WINDOWS™ (XP™, VISTA™/7/8, 10 etc.), APPLE IOS™ GOOGLE® ANDROID™, BLACKBERRY® OS, or the like.

In some embodiments, the computer system 600 may implement a web browser 608 stored program component. The web browser 608 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 608 may utilize facilities such as AJAX™, DHTML™, ADOBER FLASH™, JAVASCRIPT™, JAVA™, Application Programming Interfaces (APIs), etc. In some embodiments, the computer system 600 may implement a mail server stored program component. The mail server may be an Internet mail server such as Microsoft Exchange, or the like. The mail server may utilize facilities such as ASP™ ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 600 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage media refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD (Compact Disc) ROMs, DVDs, flash drives, disks, and any other known physical storage media.

It will be understood by those within the art that, in general, terms used herein, and are generally intended as “open” terms (e.g., the term “including” should be interpreted as “including but not limited to,” the term “having” should be interpreted as “having at least,” the term “includes” should be interpreted as “includes but is not limited to,” etc.). For example, as an aid to understanding, the detail description may contain usage of the introductory phrases “at least one” and “one or more” to introduce recitations. However, the use of such phrases should not be construed to imply that the introduction of a recitation by the indefinite articles “a” or “an” limits any particular part of description containing such introduced recitation to inventions containing only one such recitation, even when the introductory phrases “one or more” or “at least one” and indefinite articles such as “a” or “an” (e.g., “a” and/or “an” should typically be interpreted to mean “at least one” or “one or more”) are included in the recitations; the same holds true for the use of definite articles used to introduce such recitations. In addition, even if a specific part of the introduced description recitation is explicitly recited, those skilled in the art will recognize that such recitation should typically be interpreted to mean at least the recited number (e.g., the bare recitation of “two recitations,” without other modifiers, typically means at least two recitations or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following detailed description.

What is claimed is:

1. A method for retrieving response using contrastive learning of contextual retrieval augmented generation, comprising:
receiving an input text indicating a query made by a user; and
retrieving a response from one or more data sources based on the input text using a self-supervised Large Language retrieval model, wherein the self-supervised Large Language retrieval model is pre-trained by:
providing a plurality of unlabelled texts as training input data to the self-supervised Large Language retrieval model;
determining a context of each unlabelled text in the plurality of unlabelled texts using one or more Artificial Intelligence (AI) techniques;
performing an augmentation operation on each unlabelled text and the context corresponding to each unlabelled text;
generating a plurality of positive and negative query-context pairs for the unlabelled text and the corresponding context based on the augmentation operation using the self-supervised Large Language retrieval model; and
configuring the self-supervised Large Language retrieval model to retrieve the response from the one or more data sources in response to each unlabelled text.

2. The method of claim 1, further comprises training the self-supervised Large Language retrieval model by,:
receiving a plurality of test query-context representations such that each test query-context representation indicates a test query and a corresponding context of the test query;
providing labelled query-context pairs to the self-supervised Large Language retrieval model; and
optimizing the self-supervised Large Language retrieval model to retrieve the response from the one or more data sources based on the labelled query-context pairs.

3. The method of claim 2, comprises:
evaluating a quadruplet loss function by evaluating a loss between the response retrieved by the self-supervised Large Language retrieval model and an expected response, wherein the quadruplet loss function is based on the positive and negative query-context pairs for each of the unlabelled text and the corresponding context.

4. The method of claim 1, further comprises:
storing the plurality of positive and negative query-context pairs for the unlabelled text and the corresponding context as a plurality of vector embeddings that includes multimodal Vector; and
indexing the plurality of vector embeddings corresponding to the plurality of unlabelled texts.

5. A computer system, comprising:
a memory; and
one or more processors, configured to:
receive an input text indicating a query made by a user; and
retrieve a response from one or more data sources based on the input text using a self-supervised Large Language retrieval model, wherein the self-supervised Large Language retrieval model is pre-trained by:
provide a plurality of unlabelled texts as training input data to the self-supervised Large Language retrieval model;
determine a context of each unlabelled text in the plurality of unlabelled texts using one or more Artificial Intelligence (AI) techniques;
perform an augmentation operation on each unlabelled text and the context corresponding to each unlabelled text;
generate a plurality of positive and negative query-context pairs for the unlabelled text and the corresponding context based on the augmentation operation using the self-supervised Large Language retrieval model; and
configure the self-supervised Large Language retrieval model to retrieve the response from the one or more data sources in response to each unlabelled text.

6. The computer system of claim 5, wherein the one or more processors are further configured to train the self-supervised Large Language retrieval model, wherein the one or more processors are configured to:
receive a plurality of test query-context representations such that each test query-context representation indicates a test query and a corresponding context of the test query;
provide labelled query-context pairs to the self-supervised Large Language retrieval model; and
optimize the self-supervised Large Language retrieval model to retrieve the response from the one or more data sources based on the labelled query-context pairs.

7. The computer system of claim 5, wherein the one or more processors are further configured to:
evaluate a quadruplet loss function by evaluating a loss between the response retrieved by the self-supervised retrieval model and an expected response, wherein the quadruplet loss function is based on the positive and negative query-context pairs for each of the unlabelled text and the corresponding context.

8. The computer system of claim 5, wherein the one or more processors are configured to generate the plurality of positive and negative query-context pairs for the unlabelled text and the corresponding context, the one or more processors are further configured to:
store the plurality of positive and negative query-context pairs for the unlabelled text and the corresponding context as a plurality of vector embeddings; and
index the plurality of vector embeddings corresponding to the plurality of unlabelled texts.

9. The computer system of claim 5, wherein the one or more processors are configured to generate the plurality of positive and negative query-context pairs for the unlabelled text and the corresponding context, the one or more processors are further configured to:
identify a positive sample from the positive and negative query-context pair when a semantic meaning associated with an augmented unlabelled text and the corresponding context is similar to the unlabelled text and the corresponding context; and
identify a negative sample from the positive and negative query-context pair when a semantic meaning associated with an augmented unlabelled text and the corresponding context is different from the unlabelled text and the corresponding context.

10. A non-transitory computer readable media comprising instructions, when executed by a processor, causes the processor to:
receiving an input text indicating a query made by a user; and
retrieving a response from one or more data sources based on the input text using a self-supervised Large Language retrieval model, wherein the self-supervised Large Language retrieval model is pre-trained by:
providing a plurality of unlabelled texts as training input data to the self-supervised Large Language retrieval model;
determining a context of each unlabelled text in the plurality of unlabelled texts using one or more Artificial Intelligence (AI) techniques;
performing an augmentation operation on each unlabelled text and the context corresponding to each unlabelled text;
generating a plurality of positive and negative query-context pairs for the unlabelled text and the corresponding context based on the augmentation operation using the self-supervised Large Language retrieval model; and
configuring the self-supervised Large Language retrieval model to retrieve the response from the one or more data sources in response to each unlabelled text.

11. The non-transitory computer readable media of claim 10, wherein the instructions causes the processor to train the self-supervised Large Language retrieval model by,:
receiving a plurality of test query-context representations such that each test query-context representation indicates a test query and a corresponding context of the test query;
providing labelled query-context pairs to the self-supervised Large Language retrieval model; and
optimizing the self-supervised Large Language retrieval model to retrieve the response from the one or more data sources based on the labelled query-context pairs.

12. The non-transitory computer readable media of claim 10, wherein the instructions causes the processor to further perform:
evaluating a quadruplet loss function by evaluating a loss between the response retrieved by the self-supervised Large Language retrieval model and an expected response, wherein the quadruplet loss function is based on the positive and negative query-context pairs for each of the unlabelled text and the corresponding context.

13. The non-transitory computer readable media of claim 10, wherein the instructions causes the processor to further perform:
storing the plurality of positive and negative query-context pairs for the unlabelled text and the corresponding context as a plurality of vector embeddings that includes multimodal Vector; and
indexing the plurality of vector embeddings corresponding to the plurality of unlabelled texts.

14. The non-transitory computer readable media of claim 10, wherein the instructions causes the processor to generate a plurality of positive and negative query-context pairs for the unlabelled text and the corresponding context further comprising:
identifying a positive sample from the positive and negative query-context pair when a semantic meaning associated with an augmented unlabelled text and the corresponding context is similar to the unlabelled text and the corresponding context; and
identifying a negative sample from the positive and negative query-context pair when a semantic meaning associated with an augmented unlabelled text and the corresponding context is different from the unlabelled text and the corresponding context.
